(19) United States
(12) Patent Application Publication
(10) Pub. No.: US 2018/0337942 A1
(43) Pub. Date: Nov. 22, 2018

(54) QUORUM SYSTEMS AND METHODS IN SOFTWARE DEFINED NETWORKING

(71) Applicant: Ciena Corporation, Hanover, MD (US)

(72) Inventors: Aung HTAY, Alpharetta, GA (US); Michelle ZHANG, Sandy Springs, GA (US); Andrew WILLIAMSON, Lawrenceville, GA (US)

(21) Appl. No.: 15/596,363

(22) Filed: May 16, 2017

(51) Int. Cl. H04L 29/06; H04L 29/08; H04L 12/46; G06N 99/00

(52) U.S. Cl. CPC H04L 63/1441; H04L 67/10; G06N 99/005; H04L 63/1425; H04L 12/4645

(57) ABSTRACT

A Software Defined Quorum (SDQ) system implements a quorum system using Software Defined Networking (SDN). The SDQ system includes a controller/orchestrator; a plurality of compute/storage devices each comprising a normal container and a quarantine container; and a network communicatively coupling the controller/orchestrator and the plurality of compute/storage devices together; wherein the controller/orchestrator is configured to classify content in the quorum system based on policy attributes, address content to the plurality of compute/storage devices using a service tag based on networking attributes for the network, and address the content to one of the normal container and the quarantine container in each of the plurality of compute/storage devices using a first customer tag for the normal container and a second customer tag for the quarantine container based on the networking attributes.

### FIELD OF THE DISCLOSURE

The present disclosure generally relates to networking systems and methods. More particularly, the present disclosure relates to quorum systems and methods in Software Defined Networking (SDN).

### BACKGROUND OF THE DISCLOSURE

In a distributed system (computing, networking, storage, etc.), a quorum system requires a minimum number of “votes” for a distributed transaction to be allowed in the distributed system. A quorum system enforces consistent operation in a distributed system, e.g., storage, etc. For example, some conventional quorum systems include Swift, Ceph, and the like. In OpenStack, Swift manages objects in an object storage and Cinder manages volumes in block storage. Swift provides replication of accounts and containers (database replicator), and object replication (object replicator), and container-to-container synchronization through mirroring one container to another. Within Swift, there are three files that are shared among each Swift node, namely object.ring.gz, container.ring.gz, account.ring.gz. These files determine where in the cluster the data will reside. Accounts, containers, and objects each have their own ring. The ring will take x number of bits from the MD5 hash of a (object+container+account)'s name to use as a partition index, resulting in 2^{x} partitions. Each partition can have multiple replicas that are assigned to different devices in the ring, of which the number of replicas can be configured. In this way, the total number of replicas for a given partition would be (# replicas) times 2^{x}.

Ceph provides high availability data and resiliency with its Object Storage Daemon (OSD). The OSD Daemon will use the CRUSH (Controlled, Scalable, and Decentralized Placement of Replicated Data) algorithm to determine the storage location of replicas of objects.

Thus, there are a number of conventional quorum systems, but these have not been extended to Software Defined Networking (SDN) systems. SDN is an approach to computer networking that allows network administrators to manage network services through abstraction of higher-level functionality. This is done by decoupling the system that makes decisions about where traffic is sent (the control plane) from the underlying systems that forward traffic to the selected destination (the data plane). In addition to SDN, networks are moving towards the use of Virtualized Network Functions (VNFs) and the like. Enterprises are putting their data in the cloud, using Software Defined Storage (SDS) and SDN. More and more employees are working remotely and roaming. Software as a Service (SaaS) such as Office 365 can now be accessed without the traditional enterprise approved Virtual Private Network (VPN) connection. Storage in the cloud is under heightened threat from unauthorized encryption.

There is a need to adapt quorum systems to operate in an SDN environment.

### BRIEF SUMMARY OF THE DISCLOSURE

These conventional quorum systems do not have the Software Defined Quorum features. Specifically, the conventional quorum systems do not take actions based on the content identification and tenant policy and do not manipulate a networking overlay using SDN to quarantine suspect data.

In an embodiment, a Software Defined Quorum (SDQ) system configured to implement a quorum system using Software Defined Networking (SDN) includes a controller/orchestrator; a plurality of compute/storage devices each including a normal container and a quarantine container; and a network communicatively coupling the controller/orchestrator and the plurality of compute/storage devices together; wherein the controller/orchestrator is configured to classify content in the quorum system based on policy attributes, address content to the plurality of compute/storage devices using a service tag based on networking attributes for the network, and address the content to one of the normal container and the quarantine container in each of the plurality of compute/storage devices using a first customer tag for the normal container and a second customer tag for the quarantine container based on the networking attributes.

The network can include a leaf/spine network with a programmable data plane using SDN, and wherein the plurality of compute/storage devices each implement a Virtual Machine (VM) which hosts the normal container and the quarantine container. The service tag can be a Service Virtual Local Area Network Identifier (SVID), and wherein the first customer tag and the second customer tag can each be a different Customer Virtual Local Area Network Identifier (CVID). The policy attributes can be defined by a tenant and determine content type and whether modification is allowed, whether encryption is allowed, whether sampling is allowed for reporting, and associated actions.

To add a new tenant to the quorum system, the controller/orchestrator is configured to receive the policy attributes from the new tenant, allocate the service tag, the first customer tag, and the second tag for the new tenant, and create the normal container and the quarantine container on each of the plurality of compute/storage devices. To classify the content, the controller/orchestrator is configured to maintain a journal for the content correlating a unique identifier, a tenant, content type, a current customer tag including one of the first customer tag and the second customer tag, and update or populate the journal based on the policy attributes for the tenant. For suspicious content, the controller/orchestrator is configured to address the suspicious content with the second customer tag to the quarantine container on each of the plurality of compute/storage devices, and one or more of report the suspicious content and provide a sample of the suspicious content for threat intelligence.

In another embodiment, a controller/orchestrator part of a Software Defined Quorum (SDQ) system configured to implement a quorum system using Software Defined Networking (SDN) includes a network interface communicatively coupled to a network which connects to a plurality of compute/storage devices each including a normal container and a quarantine container; one or more processors communicatively coupled to the network interface; and memory storing instructions that, when executed, cause the one or more processors to classify content in the quorum system based on policy attributes, address content to the plurality of compute/storage devices using a service tag based on networking attributes for the network, and address the content to one of the normal container and the quarantine container in each of the plurality of compute/storage devices using a first customer tag for the normal container and a second customer tag for the quarantine container based on the networking attributes.

The network can include a leaf/spine network with a programmable data plane using SDN, and wherein the plurality of compute/storage devices can each implement a Virtual Machine (VM) which hosts the normal container and the quarantine container. The service tag can be a Service Virtual Local Area Network Identifier (SVID), and wherein the first customer tag and the second customer tag can each be a different Customer Virtual Local Area Network Identifier (CVID). The policy attributes can be defined by a tenant and determine content type and whether modification is allowed, whether encryption is allowed, whether sampling is allowed for reporting, and associated actions.

To add a new tenant to the quorum system, the memory storing instructions that, when executed, further cause the one or more processors to receive the policy attributes from the new tenant, allocate the service tag, the first customer tag, and the second tag for the new tenant, and create the normal container and the quarantine container on each of the plurality of compute/storage devices. To classify the content, the memory storing instructions that, when executed, further cause the one or more processors to maintain a journal for the content correlating a unique identifier, a tenant, content type, a current customer tag including one of the first customer tag and the second customer tag, and update or populate the journal based on the policy attributes for the tenant. For suspicious content, the memory storing instructions that, when executed, further cause the one or more processors to address the suspicious content with the second customer tag to the quarantine container on each of the plurality of compute/storage devices, and one or more of report the suspicious content and provide a sample of the suspicious content for threat intelligence.

In a further embodiment, a Software Defined Quorum (SDQ) method is implemented by a controller/orchestrator using Software Defined Networking (SDN), wherein the controller/orchestrator is communicatively coupled to a plurality compute/storage devices and each including a normal container and a quarantine container. The SDQ method includes classifying content in the quorum system based on policy attributes; addressing content to the plurality of compute/storage devices using a service tag based on networking attributes for the network; and addressing the content to one of the normal container and the quarantine container in each of the plurality of compute/storage devices using a first customer tag for the normal container and a second customer tag for the quarantine container based on the networking attributes.

The service tag can be a Service Virtual Local Area Network Identifier (SVID), and wherein the first customer tag and the second customer tag can each be a different Customer Virtual Local Area Network Identifier (CVID). The policy attributes can be defined by a tenant and determine content type and whether modification is allowed, whether encryption is allowed, whether sampling is allowed for reporting, and associated actions.

To add a new tenant to the quorum system, the SDQ method further include receiving the policy attributes from the new tenant; allocating the service tag, the first customer tag, and the second tag for the new tenant; and creating the normal container and the quarantine container on each of the plurality of compute/storage devices. To classify the content, the SDQ method further includes maintaining a journal for the content correlating a unique identifier, a tenant, content type, a current customer tag including one of the first customer tag and the second customer tag, and updating or populating the journal based on the policy attributes for the tenant. For suspicious content, the SDQ method further includes addressing the suspicious content with the second customer tag to the quarantine container on each of the plurality of compute/storage devices, and one or more of reporting the suspicious content and providing a sample of the suspicious content for threat intelligence.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of an example Software Defined Networking (SDN) network for describing the systems and methods presented herein;

FIG. 2 is a block diagram of functional components of an SDN environment for describing the systems and methods presented herein;

FIG. 3 is a block diagram illustrates a server which may be used to realize the SDN controller, the business applications, and/or other systems, such as a Software Defined Quorum (SDQ) system in accordance with an embodiment of the proposed solution;

FIG. 4 is a block diagram of a data center with associated components for implementing the SDQ system in accordance with an embodiment of the proposed solution;

FIG. 5 is a block diagram of the data center illustrating an implementation of the SDQ system therein and adding a tenant in accordance with an embodiment of the proposed solution;

FIG. 6 is a table of policy attributes and trigger actions and of networking attributes in an example of the SDQ system in accordance with an embodiment of the proposed solution;

FIGS. 7(a), 7(b), and 7(c) are tables illustrating different stages of a data storage operation in the SDQ system subsequent for adding the tenant T1 in accordance with an embodiment of the proposed solution;

FIG. 8 is a diagram illustrating default cabling for hosts and Top-of-Rack (TOR) switches in a rack in accordance with an embodiment of the proposed solution;

FIG. 9 is a diagram illustrating default cabling for the TOR switches and spine switches for three racks in accordance with an embodiment of the proposed solution;

FIG. 10 is a diagram illustrating data plane programming for the data center to implement the SDQ system using OpenFlow Data Plane Abstraction (OF-DPA) in accordance with an embodiment of the proposed solution;

FIG. 11 is a diagram of a compute/storage device in accordance with an embodiment of the proposed solution; and

FIG. 12 is a flowchart of an SDQ process using the controller/orchestrator and the VMs on the compute/storage devices as a SDQ system in accordance with an embodiment of the proposed solution.

### DETAILED DESCRIPTION OF THE DISCLOSURE

Again, in various embodiments of the proposed solution, the present disclosure relates to quorum systems and methods in Software Defined Networking (SDN). The systems and methods dynamically configure a programmable data plane and Virtualized Network Functions (VNFs) for the protection of quorum-based storage and the like. The proposed systems and method provide a software defined quorum using a custom designed pipeline (e.g., OpenFlow) processing. Further, the systems and methods can obtain threat intelligence for unauthorized modification and/or encryption of cloud-based storage by monitoring the network and virtual infrastructure.

The systems and methods are referred to as a Software Defined Quorum (SDQ) system and can be deployed as an overlay on top of any quorum-based system. In an implementation of an embodiment of the proposed solution, the systems and methods cover the protection of applications/workload storage data of a distributed infrastructure from unauthorized modification and/or encryption. The SDQ system can manage data in storage systems. For example, in a quorum-based system (e.g., assume three nodes), data is replicated to three diverse compute/storage systems. When data is retrieved, a majority of the compute/storage [systems] must agree on the content, to be valid. In the SDQ system of the proposed solution, when unauthorized encryption is detected, dynamically manipulates the SDN-based network overlay to “divert” the suspect data to be quarantined, and in some implementations the enterprise user can then be notified. The enterprise user either accepts or rejects the modified data. In some embodiments, the SDQ system utilizes Q-in-Q tagging to direct data to different containers in the SDQ system, e.g., a normal container and a quarantine container.

### SDN Network

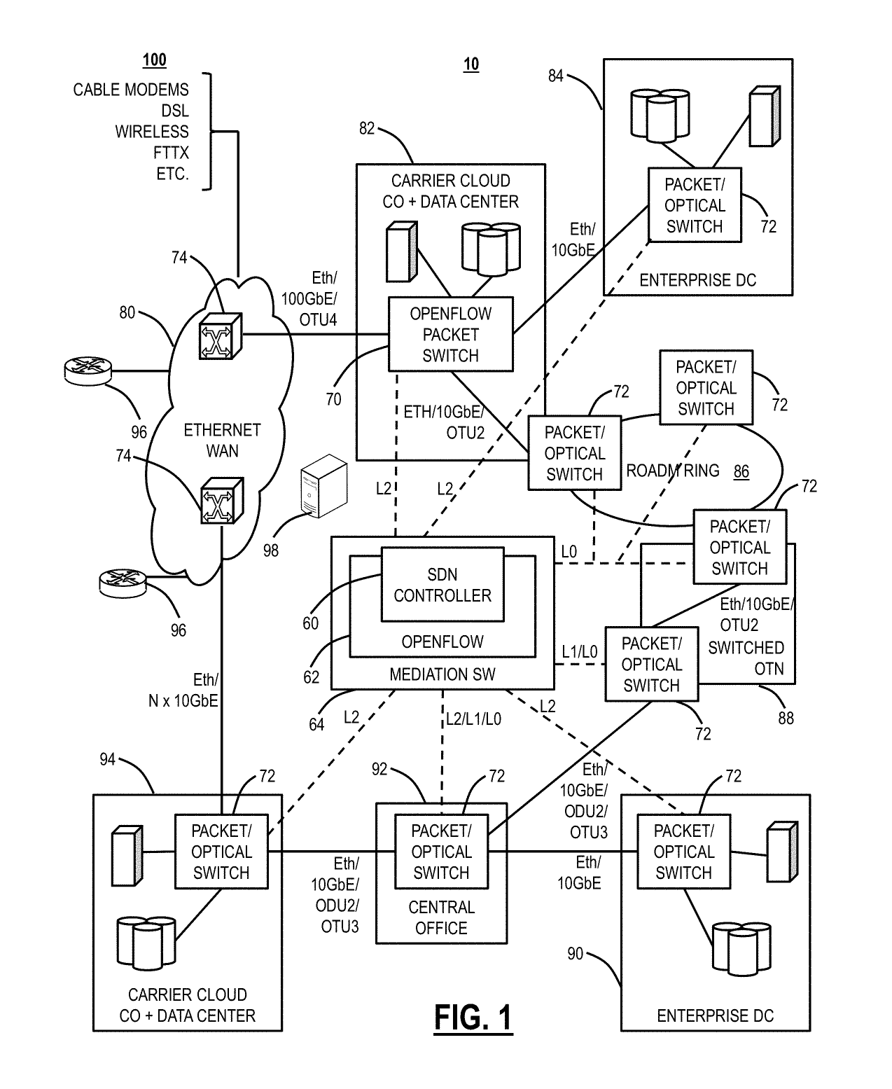

FIG. 1 is a network diagram of a SDN network 10 for describing the systems and methods proposed herein. Those of ordinary skill in the art will recognize that various network configurations are contemplated with the proposed systems and methods, and the network 10 is merely presented for illustration. The network 10 is an SDN network, which includes an SDN controller 60 with the ability to (logically) centrally program provisioning of forwarding in the network 10 in order for more flexible and precise control over network resources to support new services. Application Programmable Interfaces (APIs) provide programmatic communication between an SDN controller and either (i) specific applications or (ii) programmable network devices such as communication over Transaction Language-1 (TL-1) or Common Object Request Broker Architecture (CORBA) calls. OpenFlow (www.openflow.org) is an example implementation of a special OpenFlow interface 62 from the SDN controller 60 to programmable network devices. It may or may not communicate via mediation software 64, to each switch 70, 72, 74 in the network 10 in order to provision a forwarding table at each switch along a connection path in order to instantiate the forwarding behavior needed for the connection. OpenFlow is described, for example, in the OpenFlow Switch Speciation, Version 1.1.0 (February 2011)-Version 1.5.0 (December 2014), the contents of which are incorporated by reference herein. While OpenFlow describes one version of an SDN interface, other SDN protocols besides OpenFlow (such as Nedlow, REST, etc.) are also contemplated with the systems and methods described herein.

Again, for illustration purposes, the network 10 includes an OpenFlow-controlled packet switch 70, various packet/optical switches 72, and packet switches 74 with the switches 70, 72 each communicatively coupled to the SDN controller 60 via the OpenFlow interface 62 and the mediation software 64 at any of Layers 0-3 (for example L0 being DWDM, L1 being OTN, and L2 being Ethernet). The switches 70, 72, 74, again for illustration purposes only, are located at various sites, including an Ethernet Wide Area Network (WAN) 80, a carrier cloud Central Office (CO) and data center 82, an enterprise data center 84, a Reconfigurable Optical Add/Drop Multiplexer (ROADM) ring 86, a switched OTN site 88, another enterprise data center 90, a central office 92, and another carrier cloud Central Office (CO) and data center 94. The network 10 can also include IP routers 96 and a network management system (NMS) 98. Note, there can be more than one of the NMS 98, e.g., an NMS for each type of equipment—communicatively coupled to the SDN controller 60. Again, the network 10 is shown just to provide context and typical configurations at Layers 0-3 in an SDN network for illustration purposes. Those of ordinary skill in the art will recognize various other network configurations are possible at Layers 0-3 in the SDN network.

The switches 70, 72, 74 can operate, via SDN, at Layers 0-3. The OpenFlow packet switch 70, for example, can be a large-scale Layer 2 Ethernet switch that operates, via the SDN controller 60, at Layer 2 (L2). The packet/optical switches 72 can operate at any of Layers 0-3 in combination. At Layer 0, the packet/optical switches 72 can provide wavelength connectivity such as via DWDM, ROADMs, etc., at Layer 1, the packet/optical switches 72 can provide time division multiplexing (TDM) layer connectivity such as via Optical Transport Network (OTN), Synchronous Optical Network (SONET), Synchronous Digital Hierarchy (SDH), etc., at Layer 2, the packet/optical switches 72 can provide Ethernet or Multi-Protocol Label Switching (MPLS) packet switching and at Layer 3 the packet/optical switches can provide IP packet forwarding. The packet switches 74 can be traditional Ethernet switches that are not controlled by the SDN controller 60. The network 10 can include various access technologies 100, such as, without limitation, cable modems, digital subscriber loop (DSL), wireless, fiber-to-the-X (e.g., home, premises, curb, etc.), and the like. In an embodiment of the proposed solution, the network 10 is a multi-vendor (i.e., different vendors for the various components) and multi-layer network (i.e., Layers L0-L3).

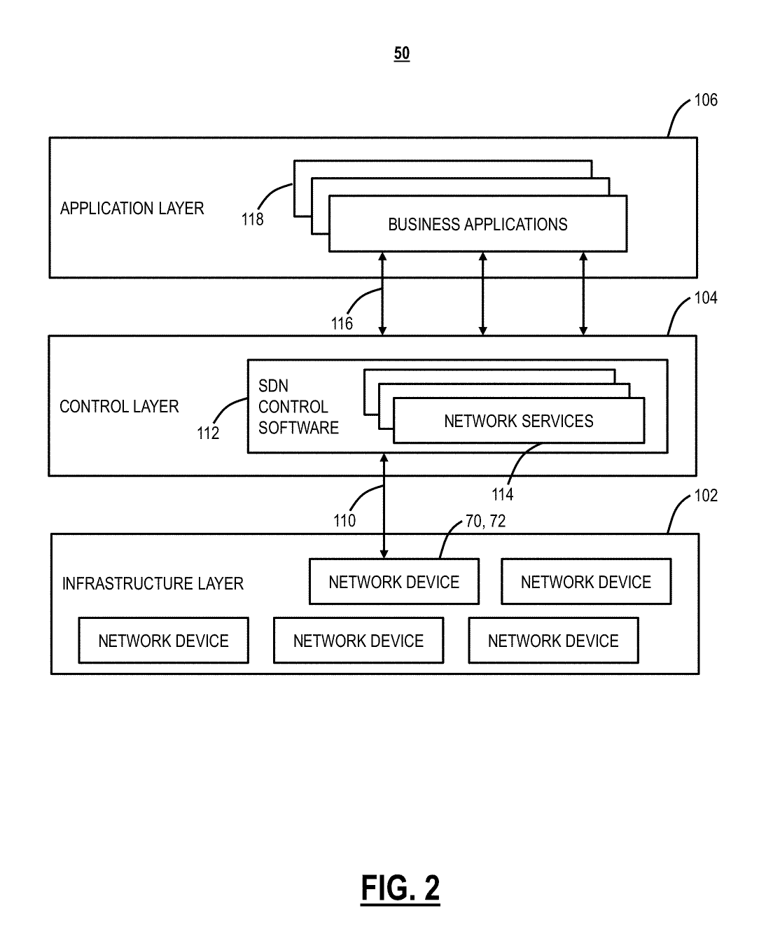

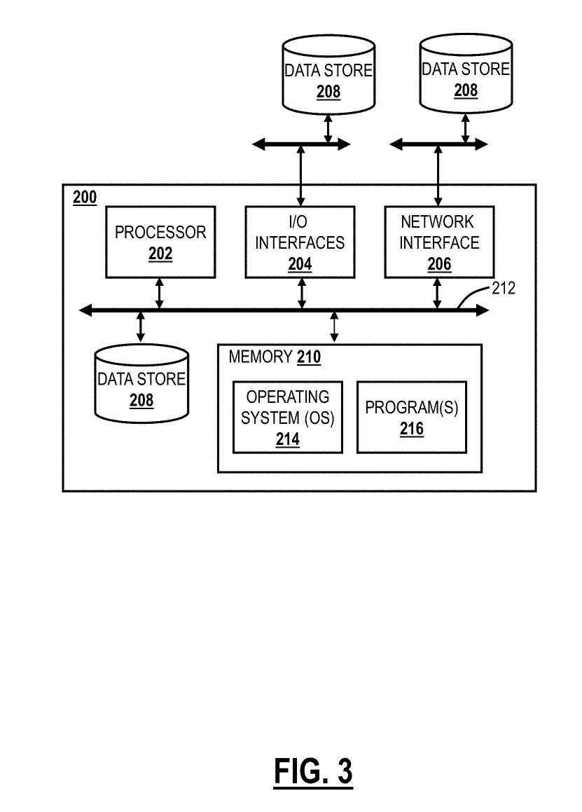

FIG. 2 is a block diagram of functional components of an SDN environment 50. The SDN environment 50 layers 104, 106 can be implemented on one or more servers, such as illustrated in FIG. 3 and the layers 104, 106 can be through functional components implemented in software executed on the server. The SDN environment 50 includes a programmable infrastructure layer 102, a control layer 104, and an application layer 106. The programmable infrastructure layer 102 includes network devices such as the switches 70, 72 and the like. The programmable infrastructure layer 102 is communicatively coupled to the control layer 104 via a control plane interface 110 such as OpenFlow, for example. The control layer 104 facilitates communication between the application layer 106 and the network devices 70, 72 located in the programmable infrastructure layer 102. The control layer 104 includes SDN control software 112 with a plurality of network services 114. The control layer 104 provides SDN functionality to manage network services through abstraction of lower level functionality. The application layer 106 communicates with the control layer 104 through various Application Programming Interfaces (APIs) 116. The application layer 106 provides end user connectivity to the SDN such as software modules and/or functions responsible for creating the desired path and flow connections on the physical network through various business applications 118. In an embodiment of the proposed solution, the systems and methods described herein are implemented as one of the business applications 118 on the SDN controller 60 and/or on a separate server 200.

### Server

FIG. 3 is a block diagram illustrating a server 200 which may be used to realize the SDN controller 60, the business applications 118, and/or other systems, such as the SDQ system. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and practical embodiments may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chip set), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components. User input may be provided via, for example, a keyboard, touchpad, and/or a mouse. The system output may be provided via a display device and a printer (not shown). I/O interfaces 204 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 206 may be used to enable the server 200 to communicate over a network, such as the Internet, a wide area network (WAN), a local area network (LAN), and the like, etc. The network interface 206 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200 such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Data Center Architecture

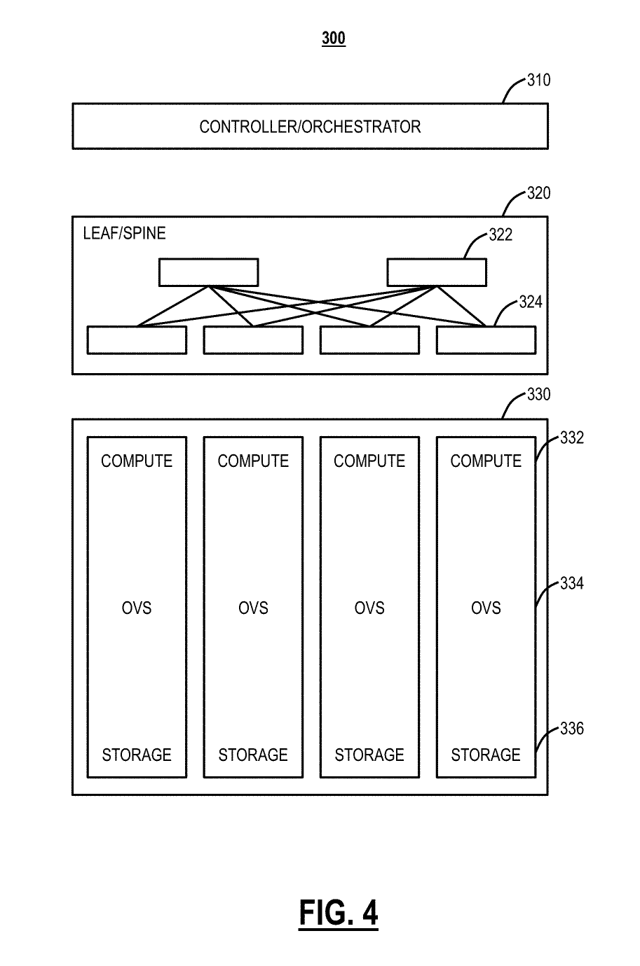

FIG. 4 is a block diagram of a data center 300 with associated components for implementing the SDQ system. Those skilled in the art will recognize the data center 300 is presented for illustration purposes only and may contain fewer or additional components as well as different architectures. The data center 300 can include a controller/orchestrator 310, a Layer 2 (L2)/Layer 3 (L3) leaf/spine network 320, and compute and storage hardware 330.

The controller/orchestrator 310 is an orchestration system that drives SDN, VNF, and the SDQ system described herein. The leaf/spine network 320 includes a combination of interconnected switches and routers, such as spine switches 322 and leaf switches 324, with a programmable data plane, controlled by the controller/orchestrator 310. For example, the programmable data plane can be OpenFlow as well as other implementations. The compute and storage hardware 330 can include compute devices 332, an Open Virtual Switch (OVS) 334, and storage devices 336. For example, the compute and storage hardware 330 and the leaf/spine network 320 can include so-called commodity hardware which implements the intelligence in the programmable data plane controlled by the controller/orchestrator 310. The OVS 334 can provide a tenant aware virtual network overlay.

The controller/orchestrator 310 can include a Virtual Infrastructure Manager (VIM). The VIM is responsible for managing the virtualized infrastructure of an NFV-based solution. VIM operations include keeping an inventory of the allocation of virtual resources to physical resources. This allows the VIM to orchestrate the allocation, upgrade, release, and reclamation of Network Functions Virtualization Infrastructure (NFVI) resources and optimize their use. The VIM supports the management of VNF forwarding graphs by organizing virtual links, networks, subnets, and ports. The VIM also manages security group policies to ensure access control. The VIM manages a repository of NFVI hardware resources (the leaf/spine network 320 and the compute and storage hardware 330) and software resources (hypervisors), along with the discovery of the capabilities and features to optimize the use of such resources.

### SDQ System—Adding a Tenant

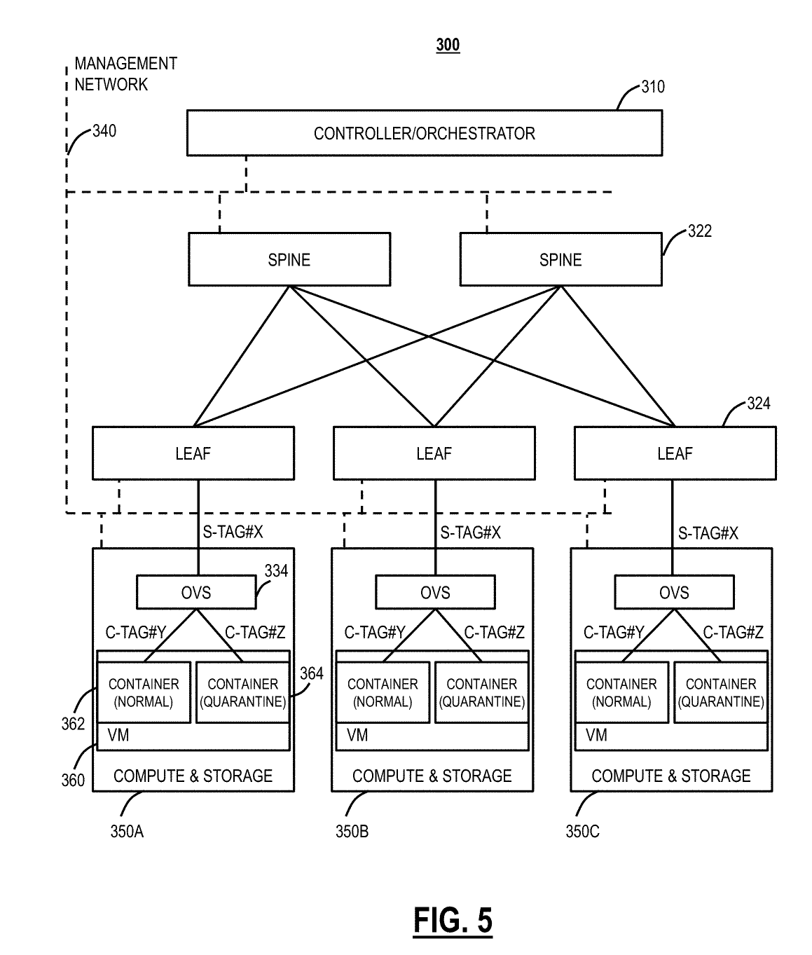

FIG. 5 is a block diagram of the data center 300 illustrating an implementation of the SDQ system therein and adding a tenant. The controller/orchestrator 310 is logically shown in FIGS. 4-5 separate from the other components, but it could run on one of the hosts in the data center 300. The controller/orchestrator 310 controls the leaf/spine network 320 and the compute and storage hardware 330 via a management network 340. The example of FIG. 5 illustrates an SDQ system with a quorum of three, specifically three compute and storage devices 350A, 350B, 350C. For example devices 350A, 350B, 350C are illustrated with the OVS 334 connected to a Virtual Machine (VM) 360 with two software containers 362, 364.

The SDQ system operates on the various components in the data center 300. For example, the SDQ system is operated through a combination of the controller/orchestrator 310 controlling the data plane to direct data via Q-in-Q tags to various quorum members, e.g., the devices 350A, 350B, 350C, and to the containers 362, 364 at each VM 360 associated with the quorum members. Specifically, the data plane is programmed to direct data to the containers 362, 364 based on associated Q-in-Q tags which are appended by the controller/orchestrator 310 operating the SDQ system. Q-in-Q is described in IEEE 802.1ad which is an amendment to IEEE standard IEEE 802.1Q-1998.

Q-in-Q tags are stacked on frames in a tag stack. In a tag stack, push and pop operations are done at the outer tag end of the stack, therefore: the tag added by a tag push operation becomes a new outer tag. The tag to be removed by a tag pop operation is the current outer tag. An inner tag is the tag which is closest to the payload portion of the frame; it is called C-Tag (Customer tag, with Ethertype 0x8100). The outer tag is the one closer/closest to the Ethernet header; its name is S-Tag (Service tag, Ethertype 0x88a8). The C-Tag is a Customer Virtual Local Area Network ID (CVID), and the S-Tag is a Service Virtual Local Area Network ID (SVID).

For illustration, the SDQ system is described with reference to adding a tenant T1, e.g., an enterprise, in the data center 300. The tenant T1 can use an Application Programming Interface (API) associated with the controller/orchestrator 310 to subscribe to a service for the SDQ system by providing policy attributes and trigger actions. For example, the API can be a REST API. The policy attributes and trigger actions define the operation of the SDQ system. The controller/orchestrator 310 can identify the data center 300, e.g., the closest data center or some other attribute based on the policy attributes and trigger actions.

The controller/orchestrator 310 can use the OpenFlow protocol to configure the leaf/spine network 320 for the networking need of the tenant T1 in the three devices 350A, 350B, 350C. For example, the controller/orchestrator 310 can use the Open vSwitch Database (OVSDB) management protocol and/or a Command Line Interface (CLI) to program the OVS 334 on each of the compute/storage devices 350A, 350B, 350C. The controller/orchestrator 310 can allocate the VM 360 per compute/storage device 350A, 350B, 350C. Preferably the controller/orchestrator 310 starts the two containers 362, 364 inside each VM 360. The container 362 is for “normal” quorum storage, and the container 364 is for “quarantine” quorum storage.

In accordance with an implementation of the proposed solution, controller/orchestrator 310 sets up networking (e.g., Q-in-Q) such that each of these containers 362, 364 in the VM 360 is reachable only through a specifically tagged Ethernet traffic. Thus, the SDQ system is now configured in the data center 300 to run between the three VMs 360.

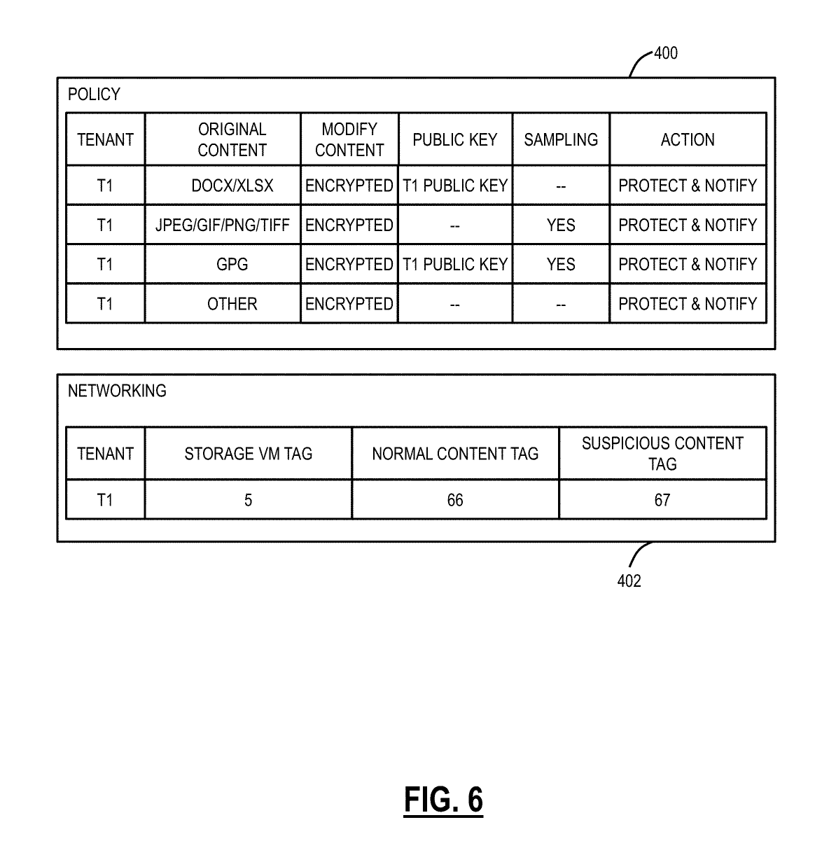

FIG. 6 is a table of policy attributes and trigger actions 400 and of networking attributes 402 in an example of the SDQ system of the proposed solution. For illustration, the SDQ system is described as a quorum-based storage system; of course, other embodiments in the context of SDN, NFV, etc. are also contemplated where the controller/orchestrator 310 controls operation. The policy attributes and trigger actions 400 are defined for the tenant T1 and what specific actions are taken. For example, in the quorum-based storage system, different content types can be specified and associated actions based on whether the content is encrypted, etc. The networking attributes 402 define the Q-in-Q tags, namely a storage VM tag (the S-tag, e.g., 5) which indicates data is for storage in the quorum-based storage system, and a normal content tag and suspicious content tag (both are the C-tag, but with different values, e.g., 66 and 67).

The intent of the policy attributes and trigger actions 400 is the tenant T1 wishes to store:

Microsoft related documents (DOCX, XLSX, etc.) in either native or GNU Privacy Guard (GPG) encrypted format. The tenant's public key is attached to validate the encrypted format. If validation fails for a document modification action, the modified document is quarantined, and the tenant is notified.

Images in native form (JPEG, GIF, PNG, TIFF, etc.), if any kind of encryption is detected, the original content is protected, and the tenant T1 wants to be notified, and the tenant will decide if the encryption was in fact intended. If the encryption is intended, a sampling of data is done at various locations, and the metadata is stored. The sampling allows for a quick detection of future unauthorized modification.

Tenant T1 also stores original GPG content. Here the public key allows for validation and samplings are stored as metadata for quick detection of unauthorized modification.

For any other content, encrypted modification triggers protection and notification.

### SDQ System—Performing Data Storage, Modification, and Recovery

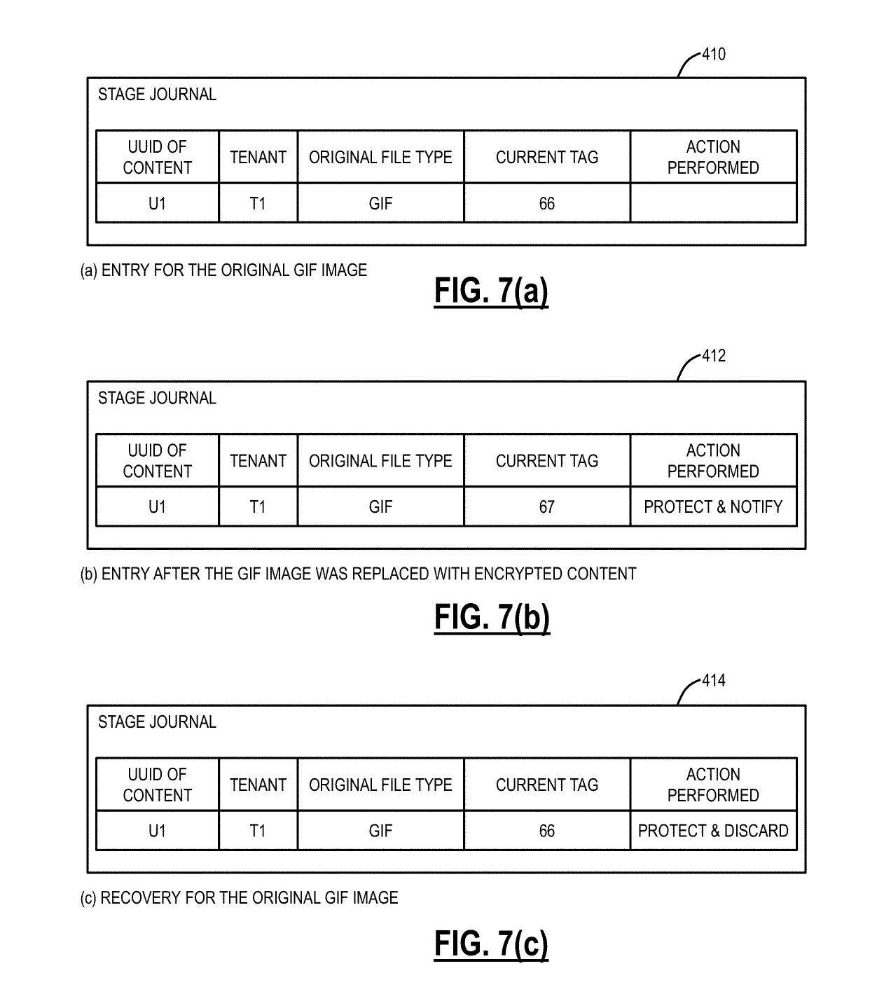

FIGS. 7(a), 7(b), and 7(c) are tables of different stages of a data storage operation in the SDQ system subsequent to adding the tenant T1. The tenant T1 uses the API to the controller/orchestrator 310 to store an example image file (e.g., a GIF). The controller/orchestrator 310 allocates a Universally Unique ID (UUID) which is associated with the image file (U1). The controller/orchestrator 310 looks up the networking attributes 402 for the tenant T1. In this example, the image file has original content, therefore the storage VM tag is set (the S-tag, e.g., 5) and the normal content tag (the C-tag, e.g., 66). The networking attributes 402 are utilized to send the image file to the right container 362 within each of the quorum VMs 360. At this point, a storage journal entry 410 illustrates the configuration in the SDQ system.

Next, consider the modification of the original content in the image file (U1). The controller/orchestrator 310 is used to modify the existing data U1. The controller/orchestrator 310 determines the type of modification (e.g., encrypting the data U1). The controller/orchestrator 310 looks up the storage journal entry 410 for U1/T1 and the policy for T1, e.g., the policy attributes and trigger actions 400. The policy attributes and trigger actions 400 indicate that the tenant T1 does not expect image files to be encrypted therefore the controller/orchestrator 310 tags the data as suspect.

As the data is now flagged as suspect, the controller/orchestrator 310 looks up the networking attributes 402 for T1 and now the storage VM tag is set (the S-tag, e.g., 5) and the suspicious content tag (the C-tag, e.g., 67) is set to send the suspect data to the quarantine container 364 within each of the quorum VMs 360. As far as the SDQ protocol is concerned, the data is replicated to the quarantine container 364. The storage journal is updated as shown in a storage journal entry 412 and the tenant T1 is notified of the suspicious content in the quarantine container 364, e.g., through the controller/orchestrator 310. Specifically, the action performed includes protecting the suspect data (storing it in the quarantine container 364) and notifying the tenant T1.

Next, consider the tenant T1 wishes to recover the original data U1 prior to the suspicious modification. The recovery of data is achieved by simply setting the C-tag of U1's storage journal back to the normal content tag (e.g., 66) and the U1 contents of the quarantine container 364 are discarded. The storage journal is updated as shown in a storage journal entry 414.

### SDQ System—Operational Details

Again, for adding the tenant T1, the controller/orchestrator 310 can identify the data center 300, e.g., the closest data center or some other attribute based on the policy attributes and trigger actions. Specifically, the controller/orchestrator 310 can do this based on the policy attributes and trigger actions based on inventory look up. For example, the controller/orchestrator 310 can pick the data center 300 (DC1) with hosts H1, H2, H3 (the compute/storage devices 350A, 350B, 350C) in diverse racks.

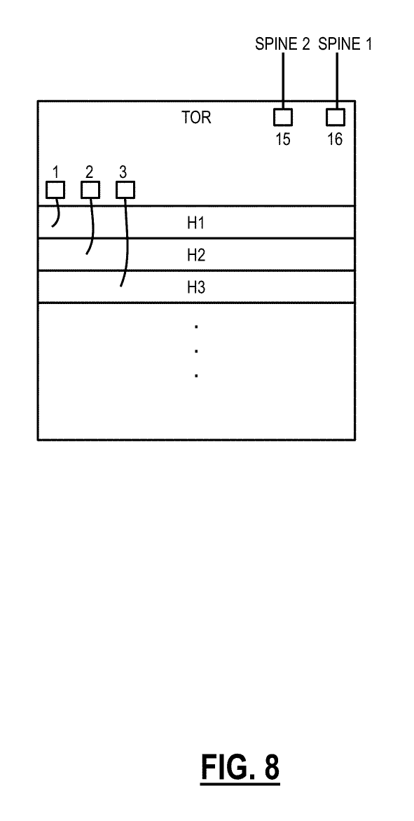

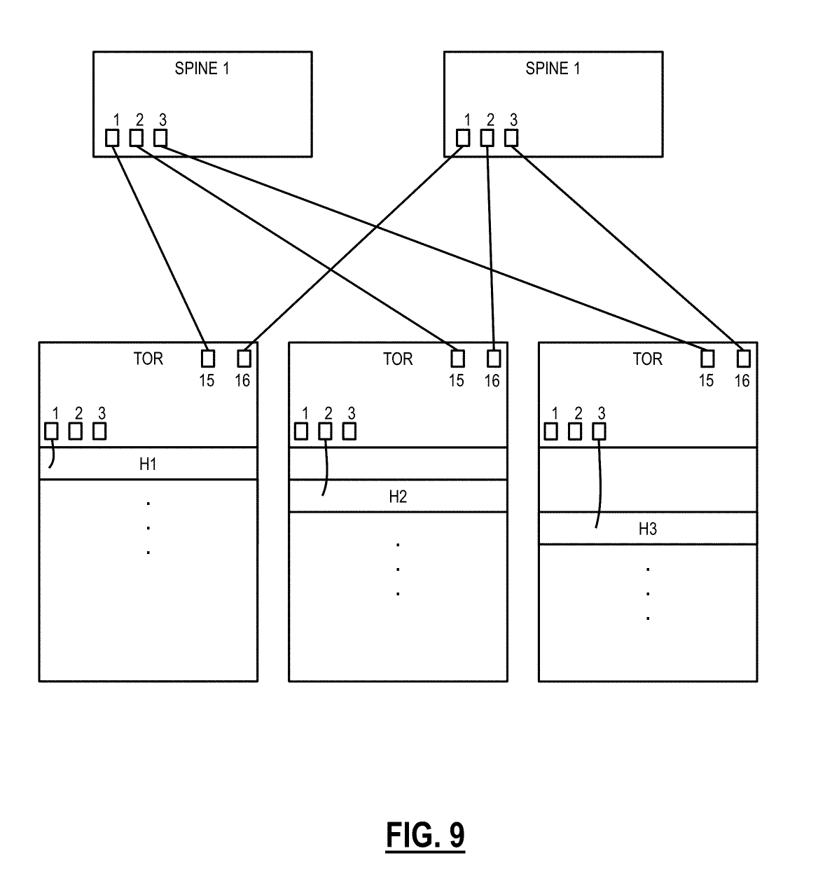

The controller/orchestrator 310 can use the OpenFlow protocol to configure the leaf/spine network 320 for the networking needs of the compute/storage devices 350A, 350B, 350C. FIG. 8 is a diagram illustrating default cabling for hosts, and Top-of-Rack (TOR) switches in a rack. FIG. 9 is a diagram illustrating default cabling for the TOR switches and spine switches for three racks.

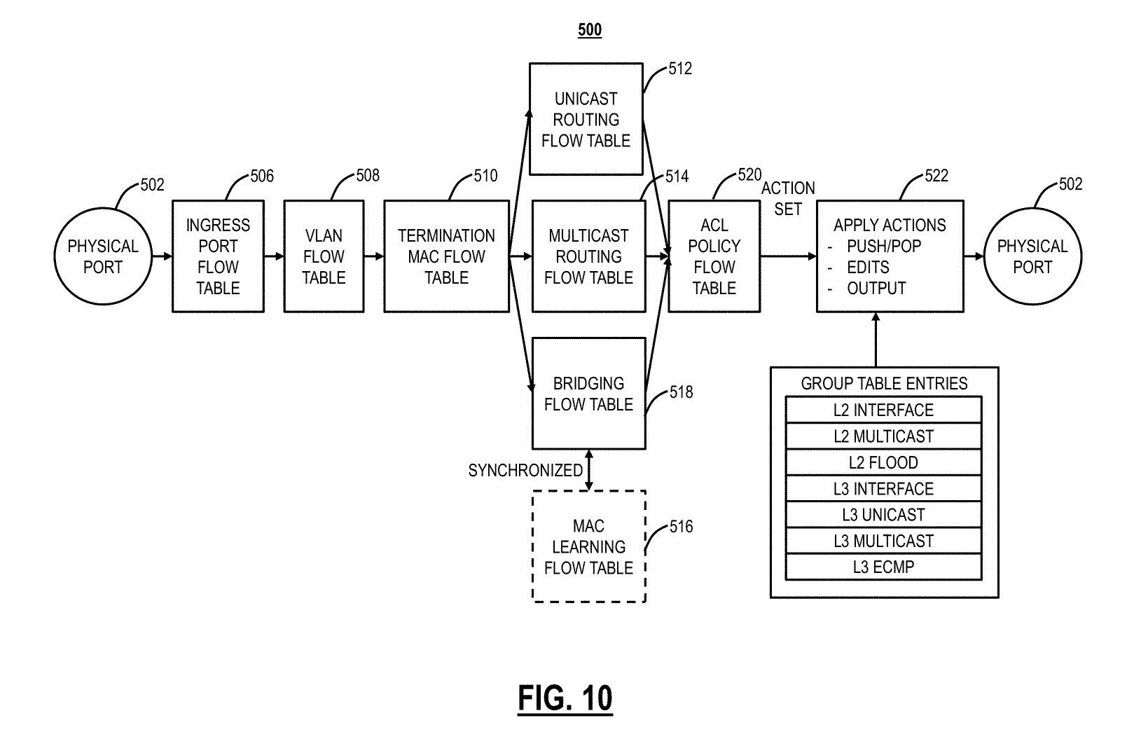

FIG. 10 is a diagram of data plane programming for the data center 300 to implement the SDQ system using OpenFlow Data Plane Abstraction (OF-DPA) 500. In SDN, for the SDQ system, OpenFlow uses programmable flow tables from the controller/orchestrator 310 in which each entry will have information in the packet and a corresponding action. For example, OpenFlow could direct everything with a Virtual Local Area Network (VLAN) tag to a specific port. The SDQ system manipulates table entries in the OF-DPA 500 pipeline to implement the actions based on policy triggers in the SDQ system.

OF-DPA is described in the OpenFlow™ Data Plane Abstraction (OF-DPA): Abstract Switch Specification Version 2.0 (Oct. 6, 2014) from Broadcom, the contents of which are incorporated by reference. Packets enter and exit the pipeline on physical ports 502, 504 local to a switch. An Ingress Port Flow Table 506 (table 0) is always the first table to process a packet. Flow entries in this table can distinguish traffic from different types of input ports by matching associated Tunnel Id metadata. Normal bridging and routing packets from physical ports 502, 504 have a Tunnel Id value of 0. To simplify programming, this table provides a default rule that passes through packets with Tunnel Id 0 that do not match any higher priority rules. All packets in the Bridging and Routing flow must have a VLAN. A VLAN Flow Table 508 can do VLAN filtering for tagged packets and VLAN assignment for untagged packets. If the packet has more than one VLAN tag, the outermost VLAN Id is the one used for forwarding.

A Termination MAC Flow Table 510 matches destination Media Access Control (MAC) addresses to determine whether to bridge or route the packet and, if routing, whether it is unicast or multicast and there are associated tables 512, 514. MAC learning is supported using a “virtual” flow table 516 that is logically synchronized with a Bridging Flow Table 518. When MAC learning is enabled, OF-DPA does a lookup in the Bridging Flow Table 516 using the source MAC, outermost VLAN Id, and IN PORT. A miss is reported to the controller/orchestrator 310 using a Packet In message. Logically this occurs before the Termination MAC Flow Table lookup. The MAC Learning Flow Table 318 cannot be directly read or written by the controller/orchestrator 310. An Access Control List (ACL) Policy Flow Table 520 can perform multi-field wildcard matches, analogous to the function of an ACL in a conventional switch.

The OF-DPA 500 pipeline makes extensive use of OpenFlow Group entries, and most forwarding and packet edit actions 522 are applied based on OpenFlow group entry buckets. At this stage, and in accordance with the proposed solution, the controller/orchestrator 310 can apply the policy attributes and trigger actions 400 by manipulating the C-tag appropriately whereas the preceding stages apply the networking attributes 402.

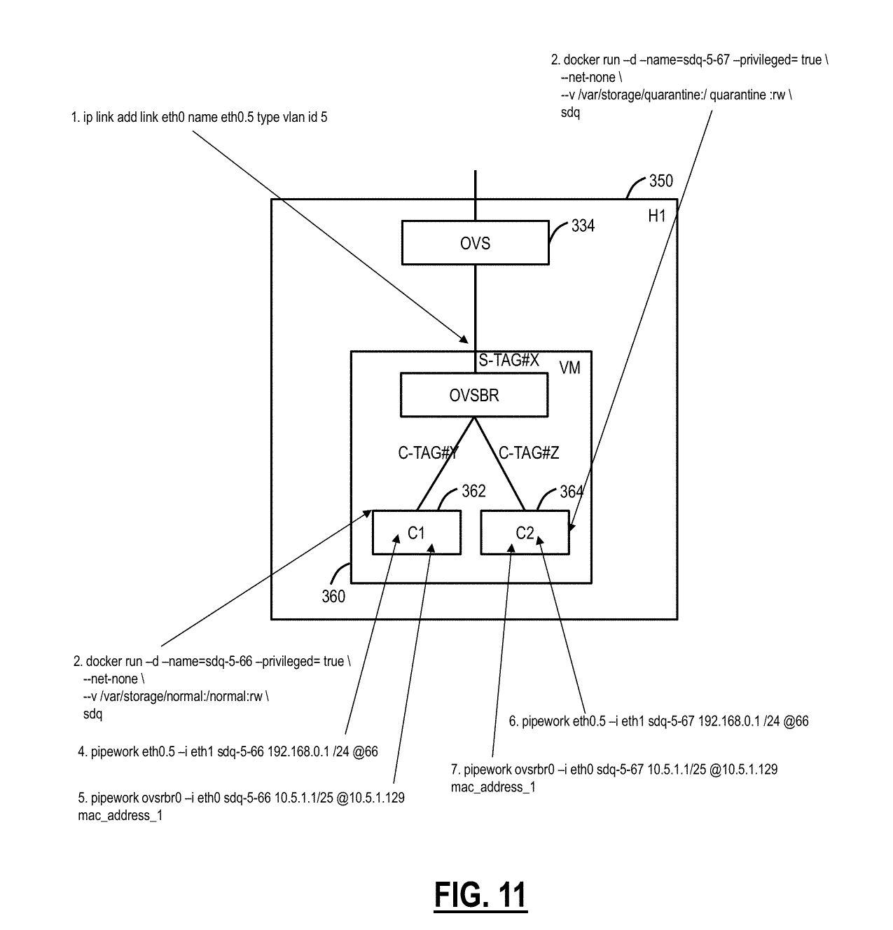

FIG. 11 is a diagram of the compute/storage device 350. Again, the compute/storage device 350 is a host (e.g., H1) in the data center 300. The controller/orchestrator 310 can use the Open vSwitch Database (OVSDB) management protocol and/or command line interfaces (e.g., ovs-vsctl and ovs-ofctl) to program the OVS 334 on each of the compute/storage devices 350. Preferably, the OVS 334 on each compute/storage device 350 will be managed in such a way that it would be connected to the two containers 362, 364. FIG. 11 illustrates the commands for establishing the containers 362, 364 on the VM 360.

The controller/orchestrator 310 allocates one VM 360 per compute/storage device 350. The controller/orchestrator 310 causes an SDQ container image to be downloaded to the appropriate container 362, 364. As described herein, the controller/orchestrator 310 starts the two containers 362, 364 inside each VM 360. For example, one container is for “normal” quorum storage. Preferably the second container is for “quarantine” quorum storage. With the networking attributes 402, the controller/orchestrator 310 sets up networking (e.g., Q-in-Q) so that each of these containers 362, 364 in the VM 360 is reachable only through a specifically tagged Ethernet traffic.

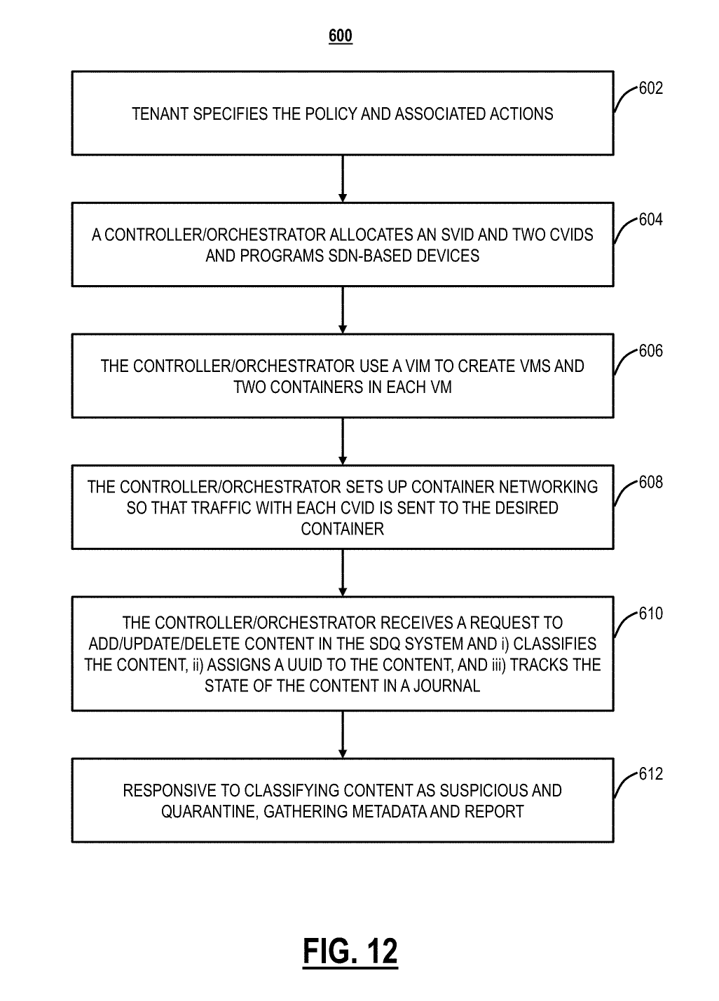

FIG. 12 is a flowchart of an SDQ process 600 using the controller/orchestrator 310 and the VMs 360 on the compute/storage devices 350A, 350B, 350C as an exemplary SDQ system in accordance with the proposed solution. An SDQ-based storage protocol is run between the VMs 360 on the compute/storage devices 350A, 350B, 350C. The controller/orchestrator 310 together with the VMs 360 appear to the outside world as the SDQ system.

The SDQ process 600 includes the tenant specifying the policy and associated actions (step 602). For example, this can include the policy attributes and trigger actions 400. The controller/orchestrator 310 allocates an SVID and two CVIDs and programs the SDN-based devices (step 604). For example, this can include the networking attributes 402. The controller/orchestrator 310 can be an SDN controller, an orchestrator, a proxy, an API gateway, or the like.

The controller/orchestrator 310 uses a VIM (e.g., OpenStack) to create the VMs 360 and the two containers 362, 364 in each VM 360 (step 606). For example, the controller/orchestrator 310 can download the container image to each VM 360 and cause the containers 362, 364 to start in each VM 360. The controller/orchestrator 310 sets up container networking so that traffic with each CVID is sent to the desired container 362, 364 (step 608).

The controller/orchestrator 310 receives a request to add/update/delete content in the SDQ system and the controller/orchestrator 310 i) classifies the data content, ii) assigns a UUID to the content, and iii) tracks the state in a journal, for example (step 610). For example, the journal can be the storage journal entry 410, 412, 414. Depending on the tenant's policy, the controller/orchestrator 310 classifies the content as normal data or quarantine data. The controller/orchestrator 310 adds the SVID and the CVID for normal or quarantine respectively before sending out to the VMs 360 in the SDQ system. The pre-programmed OVS 334 ensures that the content is directed to the correct container for the CVID.

In accordance with the proposed solution, responsive to classifying the content as suspicious and quarantine, the controller/orchestrator 310 can gather metadata from the content and/or report (step 612). The metadata can be anonymized and provided for various uses as threat intelligence.

### Exemplary Operation

With the SDQ system with the three compute/storage devices 350A, 350B, 350C and using the policy attributes and trigger actions 400 and the networking attributes 402, assume the tenant posts an image file (“dog.gif”).

POST api/v1/storage
{

“file”: “dog.gif”

}

The controller/orchestrator 310 assigns the UUID, U1:

{

“file”: “dog.gif”,
“uuid”: “U1”

}

The file content can be checked through the controller/orchestrator 310. For example, the OD command is used here for illustration, and the controller/orchestrator 310 can access the raw bytes directly from the file:

od -c -b -N 16 dog.gif
0000000 GIF 89 a364001 _ 001 346 \0 \0 333 Ö̅ **

107 111 106 070 071 141 364 001 137 001 346 000 000 333

0000020

The file content contains “GIF89” which allows for identification as an image. The controller/orchestrator 310 allocates an UUID value U1. Since this is the original storage action, the controller/orchestrator 310 looks up the policy and networking configuration for T1 (the policy attributes and trigger actions 400 and the networking attributes 402). The controller/orchestrator 310 stores the contents of dog.gif as a normal file to the three VMs 360 in the compute/storage devices 350A, 350B, 350C associated with the SDQ system. The controller/orchestrator 310 utilizes S-Tag 5 (SVID) to direct to the correct VMs 360, and C-Tag 66 (Normal) (CVID) to direct to correct container 362 within the VM 360:

Operation: Push
VLAN Type: C-VLAN (0x8100)
Value: 66
Operation: Push
VLAN Type: S-VLAN (0x88a8)
Value: 5

The controller/orchestrator 310 adds the storage journal entry 410 to record the U1/T1 metadata:

POST api/v1/journal
{

“uuid”: “U1”,
“tenant”: “T1”,
“originalFileType”: “GIF”,
“currentTag”: 66

}

Now, assume the tenant posts a modification to existing data associated with UUID U1:

PUT api/v1/storage/U1
{

“file”: “dog.gif.gpg”

}

The controller/orchestrator 310 looks up the journal entry for U1. The reply indicates that U1 is for T1 and the controller/orchestrator 310 identifies the policy associated with tenant T1.

GET api/v1/journal/U1
Reply:
{

“uuid”: “U1”,
“tenant”: “T1”,
“originalFileType”: “GIF”,
“currentTag”: 66

}

The file contents are checked. Again, the command OD is used for illustration:

od -c -b -N 16 dog.gif.gpg
0000000 - - - - - B E G I N P G P M

055 055 055 055 055 102 105 107 111 116 040 120 107 120

040 115
0000020

According to the tenant T1's policy for original image contents, the modification contains suspect data (PGP encryption), so the controller/orchestrator 310 moves the modified data to the quarantine container 364. The controller/orchestrator 310 utilizes the CVID 67 and the SVID 5 combination to quarantine the content, and the controller/orchestrator 310 notifies the tenant T1:

Operation: Push
VLAN Type: C-VLAN (0x8100)
Value: 67
Operation: Push
VLAN Type: S-VLAN (0x88a8)
Value: 5

The controller/orchestrator 310 updates the U1 entry in the stage journal to record the current tag:

PUT api/v1/journal/U1
{

“uuid”: “U1”,
“tenant”: “T1”,
“originalFileType”: “GIF”,
“currentTag”: 67
“action”: [“Protect”, “Notify”]

}

In response to the notification about the suspicious data of U1 from the controller/orchestrator 310, the tenant T1 may allow for the modification of U1 on a case by case basis. Here T1 requests the controller/orchestrator 310 for the acceptance of the U1 modification. The controller/orchestrator 310 retrieves the T1's networking attributes 402 for the normal tag value (66). The controller/orchestrator 310 retrieves U1 data using the journal's current tag (67), sends the retrieved data with the normal tag (66). If successful, the journal's entry is updated with the current tag of 66. The controller/orchestrator 310 sends a DELETE request with SVID==5 and CVID==67 to discard the quarantined data.

POST api/v1/requests
{

“uuid”: “U1”,
“tenant”: “T1”,
“action”: “Allow”

}
GET api/v1/journal/U1
Reply:
{

“uuid”: “U1”,
“tenant”: “T1”,
“originalFileType”: “GIF”,
“currentTag”: 67
“action”: [“Protect”, “Notify”]

}
PUT api/v1/journal/U1
{

“uuid”: “U1”,
“tenant”: “T1”,
“originalFileType”: “GIF”,
“currentTag”: 66
“action”: [“Allow”, “Discard”]

}

For the recovery of data, in response to the notification about the suspicious data of U1 from the controller/orchestrator 310, the tenant T1 may wish to recover the original data. Recovery of data is simply achieved by the controller/orchestrator 310 setting the “currentTag” of the U1's journal entry to be 66. The normal behavior of the SDQ system then resumes with the tag 66. The controller/orchestrator 310 sends a DELETE request with SVID==5 and CVID==67 to discard the quarantined data.

POST api/v1/requests
{

“uuid”: “U1”,
“tenant”: “T1”,
“action”: “Recovery”

}
PUT api/v1/journal/U1
{

“uuid”: “U1”,
“tenant”: “T1”,
“originalFileType”: “GIF”,
“currentTag”: 66
“action”: [“Recovery”, “Discard”]

}

### Content Detection

For illustration, assume PGP is used, and the encrypted output is in the form of ASCII armored. In another implementation, the concept of Linux filed command with its magic database can be used or similar. Again, for illustration purposes, two key pairs are created—one for a good guy and one for a bad guy:

vagrant@vagrant-ubuntu-trusty-64:~$ gpg --list-keys
/home/vagrant/.gnupg/pubring.gpg
--------------------------------
pub 2048R/3DAA7887 2017-01-22
uid Aung Htay (Good guy Test Key) <ahtay@ciena.com>
sub 2048R/81161BDA 2017-01-22
pub 2048R/189638F7 2017-01-22
uid Bad Guy (Bad Guy Key for Testing) <bad@ciena.com>
sub 2048R/A7E8DE08 2017-01-22
vagrant@vagrant-ubuntu-trusty-64:~$

Consider a text file containing the phrase ‘hello world.’ In the use case for original data as plain text, it is a simple matter to identify that the file has been encrypted without authorization. The first command line is for encrypting the file ‘hello.txt’ containing ‘hello world’ with the bad guy's private key. The second command line shows the difference between the original content and the encrypted content.

vagrant@vagrant-ubuntu-trusty-64:~$ gpg -rbad@ciena.com --output
hello_bad.txt.gpg --armor --encrypt hello.txt
vagrant@vagrant-ubuntu-trusty-64:~$ diff hello.txt hello_bad.txt.gpg
1c1,13
< hello world
---
> -----BEGIN PGP MESSAGE-----
> Version: GnuPG v1
>
> hQEMAycjjAun6N4IAQf+Mo3C/JLpCCLillk27QwQ9i1YugJ2MS1mIrg1D5rwqmt+
> dMBUoVdNj1BK39m5ojaQgxhHPl3QOQzfrgF8P8tmZqqG9F5chFf1yktctPo7MGqa
> WF14o0oeg5BT2KdnNPrhlLK/QOSLV8RFKUusgmEa9p2cIvEKEwm3iwe6M3KgvA5d
> 2VVuB6YHkoc0id/TWhD5xSVU4TqM/2dCnwF2AFbhyLTo7ZYEQ9FVechmJ1g9HuZ/
> 7Zi53SFzT4YNY0rENrAv6NsG8bEY/lOQ9rCXxdBcQNZoLOa/IRpnJ+YwamA21BWc
> xrG63YrhGVnX+Gz6aDnOuM2MvKnVGUW8TcFDpEZiTtJNAd1FLjUdIiGsd2OpaPhT
> BWpO04Ir8JWD+B1s0CngApN4oTZCmWZZWDY15Gz2qxgZNCx/wPGmJQiuuuwtKwVS
> 0Bd4w6rMrlW1GNjfJpQ=
> =E45I
> -----END PGP MESSAGE-----

For a second use case with the original data as encrypted text, assume the content is legitimately encrypted by the tenant or a user:

vagrant@vagrant-ubuntu-trusty-64:~$ gpg -rahtay@ciena.com --output
hello_ahtay.txt.gpg --armor --encrypt hello.txt
vagrant@vagrant-ubuntu-trusty-64:~$ diff hello.txt hello_ahtay.txt.gpg
1c1,13
< hello world
----
> -----BEGIN PGP MESSAGE-----
> Version: GnuPG v1
>
> hQEMAwLxQvyBFhvaAQf/XO9tqG+9a9rIXvjI0petDTIvde68gnNQwuCePptQJJcm
> xnHMDw67Ymi6mahlCAgL3GXZwBshdx2wV495qcsaasu6JT3i77O8dSaVQS3GZw6z
> 7vhYyHiS2fGc4IusSKqcGYcxKihsWjSldDUDSuNgHponEWwfuiIJd+AasuQhal/n
> gGYrcvqgViP8aT70yZCoUpdpBS2cl6Kk2Jjp8yiT/Yi3NebqCn36cmR3wCxsvmzW
> mmCTN3Bmpxj7Qd81BPvako/5ZJQtcx657CkbAOYZGSIzI94+bdBLRQxegpmU8ByX
> upm4uBqNkbAbmmH11rihCsIEQuoowKRYcOrcQMu4RNJNAaGjXPqoV9F/5CUR4p0y
> HeyIrlaP997XV8nCxPwR/gibNGL+up/tnnd4DcgYyzrk96pES9xSiEmec2hLL+mg
> BLMeOa/Blph/4v1qQo8=
> =NBq9
> -----END PGP MESSAGE-----

When the encrypted content is one more time encrypted with the unauthorized bad guy's key, it can be detected with minimum bytes at the start of the content:

vagrant@vagrant-ubuntu-trusty-64:~$ gpg -rbad@ciena.com --output
hello_bad_over_ahtay.txt.gpg --armor --encrypt hello_ahtay.txt.gpg
vagrant@vagrant-ubuntu-trusty-64:~$ diff hello_ahtay.txt.gpg
hello_bad_over_ahtay.txt.gpg
4,12c4,21
< hQEMAwLxQvyBFhvaAQf/XO9tqG+9a9rIXvjI0petDTIvde68gnNQwuCePptQJJcm
< xnHMDw67Ymi6mahlCAgL3GXZwBshdx2wV495qcsaasu6JT3i77O8dSaVQS3GZw6z
< 7vhYyHiS2fGc4IusSKqcGYcxKihsWjSldDUDSuNgHponEWwfuiIJd+AasuQhal/n
< gGYrcvqgViP8aT70yZCoUpdpBS2cl6Kk2Jjp8yiT/Yi3NebqCn36cmR3wCxsvmzW
< mmCTN3Bmpxj7Qd81BPvako/5ZJQtcx657CkbAOYZGSIzI94+bdBLRQxegpmU8ByX
< upm4uBqNkbAbmmH11rihCsIEQuoowKRYcOrcQMu4RNJNAaGjXPqoV9F/5CUR4p0y
< HeyIrlaP997XV8nCxPwR/gibNGL+up/tnnd4DcgYyzrk96pES9xSiEmec2hLL+mg
< BLMeOa/Blph/4v1qQo8=
< =NBq9
----
> hQEMAycjjAun6N4IAQf9FV6cqmx/p8EWA7V0O9GhnsH+Uid2GIC4L9YiE12fHV1S
> ZU/XIjESs8rVreppEdq91R5cXwEhLhn2kHykpJB9Omg9G3fi7LFsbZslBUwdXNi2
> MpNEAfy2svUKbNGzOjNgQV1YKCtd3hcLRrVckergKwwab4eYQOZHOZlz+qY3n9Nw
> pHy1CVf82Ajgr1rBBrmrzbDAYUmzasmxfXnl3qU1zXEMh3cdmdqqI8QTdCn/x59C
> OveH50jSGGX+0bz8J9B6MXg3kRMJxOhgym04bEfrD8UPQrUufogEAIUNNpVpXI2a
> dbRHzt/C0xHQR0MlGYJCR3lwlC8gU2HrKurh4mgIgdLpARTE0AZ6jLU83E+WMKIO
> pumgRAyXTYOeb/wxCIFpN9qoqtsfQOEdEAAbxjDlZXjDyGZnUedyxyJzwziBnaFN
> /QIRasSQFe1k+B29AWwCZHf87LHYlt5FfRLWOsPB3mRlpEWrQHa4HD3bwxpVrO0e
> gPq63KSmJzA9tWM+WSDe9ebyB0vnykWbBPW+wEDDgxEVD40tcja306GwZWmso/NB
> bK6Jf7bYO9ug9V93u+PjcXCZR+3iWDXHXnOULEv/7F5jnY+iTAKCf4SCj4HmmwcA
> X954+UjPof/wlfystByMIvHMAo/YazVaNep0QkBYtmB+Mkin53jxJed4Qg9MbBIK
> xZV/lv3ddKSyPDtyuoNjAD7fCGvu9PEstmKtmpxJfNnjcaVrPsjeI5dO/N4i3EEW
> zf+aX9oFQWOGXDBBFElRol/pTGZALHcaddveQ9ro9jsgyjca6RR/MALzD9RJMFkN
> 4IaujcQvVzcO4ySwvzPe/tq+na20iGYZaV9n7ht6g5IpOCNNIZbukiE9uRICO+UN
> DyFPCefTjbD39scz5HTrB+C/j/vpGyundgR+W1Xw8GwjJnZlqwFk6BNpr62zQG6n
> hZ/cWrqf8scEErRoFHnDadnOaPGAC1jGdGfAzd+DolgT23lWlrYUHnQMzkWYyyyI
> 0aRfmHzyWIeaNHQaR7I6N5sQUxaZnt7fzmruZmXROhvUXA==
> =9yJW
vagrant@vagrant-ubuntu-trusty-64:~$

In the example above, a minimum number of bytes (6 bytes—“hQEMAw” versus “hQEMAy”) can be used to detect the unauthorized encryption. As mentioned above, without using the ASCII armored output, a key ID can be obtained:

od -x hello_test.gpg

| | | | | | | | | |
|---|---|---|---|---|---|---|---|---|
| 0000000 | 0185 | 030c | c810 | 7d3e | a3c8 | 83f0 | 0701 | 67ff |
| 0000020 | 712e | ca93 | 23c0 | fc58 | cabc | e46d | 327c | 093f |
| 0000040 | 075c | e583 | 9922 | 6a16 | fe72 | 5027 | d7ba | 9603 |
| 0000060 | 4b24 | 6c27 | df54 | a770 | 339d | cfae | ae3f | 1d80 |
| 0000100 | 6008 | 124c | 4f5b | 3c40 | 485b | bcf9 | 7c04 | 87c0 |
| 0000120 | d55d | 8ae6 | 3bcd | fabe | 611a | 03bb | 0112 | beaf |
| 0000140 | d884 | c0da | 2dae | 5d2b | 7276 | 1563 | a3c2 | 5833 |
| 0000160 | 0061 | 59d7 | f817 | f0c0 | 1891 | f4ea | 3758 | 5b4e |
| 0000200 | 1b7f | de18 | ab78 | 3c88 | 17e3 | 9ea0 | e446 | efa7 |
| 0000220 | 8812 | 5830 | c230 | fa59 | d794 | e2a2 | b0c9 | 36aa |
| 0000240 | 3598 | bf95 | e358 | bba8 | c92d | 2916 | 9344 | fb01 |
| 0000260 | de44 | bed8 | 6b3f | eb17 | 2707 | 80e7 | f97d | 9114 |
| 0000300 | 7c47 | 7042 | ffe9 | c429 | 1b39 | 8961 | 51f8 | be0e |
| 0000320 | c012 | 6bad | f42c | 60ef | 87ad | a1ca | 6526 | b146 |
| 0000340 | 7c67 | ade9 | e857 | bda4 | 9a4b | bd1d | 9620 | 5c32 |
| 0000360 | 6e64 | ac02 | 2127 | 4c07 | 7baf | cbdd | 3a82 | 4a00 |
| 0000400 | 2996 | d9de | 0e01 | 510c | d916 | bd07 | dc96 | d227 |
| 0000420 | 014d | bac4 | 0a30 | 9093 | 9120 | b146 | 148a | 56b2 |
| 0000440 | 8a85 | 5007 | ef3a | 223f | 2197 | 3690 | 8859 | f118 |
| 0000640 | 9752 | 10a3 | ef5a | a08f | 9041 | f398 | a47d | 41fa |
| 0000500 | 312d | d2c4 | 5149 | d993 | d57c | eff6 | d572 | 1d96 |
| 0000520 | 61c2 | da81 | 71f4 | 64ba | eab0 | eab0 | d65c | |
| 0000536 | | | | | | | | |

$ file *.gpg
hello_test.gpg: PGP RSA encrypted session key - keyid: 7D3EC810
83D0A3C8 RSA (Encrypt or Sign) 2048b

### Sampling

In the case of original content with symmetric key encryption (e.g., AES, Blowfish, DES, etc.), the file content can be sampled at a number of locations and kept with the journal entry. This sampling allows for the quick detection of unauthorized modification.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the exemplary embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various exemplary embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various exemplary embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A Software Defined Quorum (SDQ) system configured to implement a quorum system using Software Defined Networking (SDN), the SDQ system comprising:
a controller/orchestrator;
a plurality of compute/storage devices each comprising a normal container and a quarantine container; and
a network communicatively coupling the controller/orchestrator and the plurality of compute/storage devices together;
wherein the controller/orchestrator is configured to
classify content in the quorum system based on policy attributes,
address content to the plurality of compute/storage devices using a service tag based on networking attributes for the network, and
address the content to one of the normal container and the quarantine container in each of the plurality of compute/storage devices using a first customer tag for the normal container and a second customer tag for the quarantine container based on the networking attributes.

2. The SDQ system of claim 1, wherein the network comprises a leaf/spine network with a programmable data plane using SDN, and wherein the plurality of compute/storage devices each implement a Virtual Machine (VM) which hosts the normal container and the quarantine container.

3. The SDQ system of claim 1, wherein the service tag is a Service Virtual Local Area Network Identifier (SVID), and wherein the first customer tag and the second customer tag are each a different Customer Virtual Local Area Network Identifier (CVID).

4. The SDQ system of claim 1, wherein the policy attributes are defined by a tenant and determine content type and whether modification is allowed, whether encryption is allowed, whether sampling is allowed for reporting, and associated actions.

5. The SDQ system of claim 1, wherein, to add a new tenant to the quorum system, the controller/orchestrator is configured to
receive the policy attributes from the new tenant,
allocate the service tag, the first customer tag, and the second tag for the new tenant, and
create the normal container and the quarantine container on each of the plurality of compute/storage devices.

6. The SDQ system of claim 1, wherein, to classify the content, the controller/orchestrator is configured to
maintain a journal for the content correlating a unique identifier, a tenant, content type, a current customer tag comprising one of the first customer tag and the second customer tag, and
update or populate the journal based on the policy attributes for the tenant.

7. The SDQ system of claim 1, wherein, for suspicious content, the controller/orchestrator is configured to
address the suspicious content with the second customer tag to the quarantine container on each of the plurality of compute/storage devices, and
one or more of report the suspicious content and provide a sample of the suspicious content for threat intelligence.

8. A controller/orchestrator part of a Software Defined Quorum (SDQ) system configured to implement a quorum system using Software Defined Networking (SDN), the controller/orchestrator comprising:
a network interface communicatively coupled to a network which connects to a plurality of compute/storage devices each comprising a normal container and a quarantine container;
one or more processors communicatively coupled to the network interface; and
memory storing instructions that, when executed, cause the one or more processors to
classify content in the quorum system based on policy attributes,
address content to the plurality of compute/storage devices using a service tag based on networking attributes for the network, and
address the content to one of the normal container and the quarantine container in each of the plurality of compute/storage devices using a first customer tag for the normal container and a second customer tag for the quarantine container based on the networking attributes.

9. The controller/orchestrator of claim 8, wherein the network comprises a leaf/spine network with a programmable data plane using SDN, and wherein the plurality of compute/storage devices each implement a Virtual Machine (VM) which hosts the normal container and the quarantine container.

10. The controller/orchestrator of claim 8, wherein the service tag is a Service Virtual Local Area Network Identifier (SVID), and wherein the first customer tag and the second customer tag are each a different Customer Virtual Local Area Network Identifier (CVID).

11. The controller/orchestrator of claim 8, wherein the policy attributes are defined by a tenant and determine content type and whether modification is allowed, whether encryption is allowed, whether sampling is allowed for reporting, and associated actions.

12. The controller/orchestrator of claim 8, wherein, to add a new tenant to the quorum system, the memory storing instructions that, when executed, further cause the one or more processors to
receive the policy attributes from the new tenant,
allocate the service tag, the first customer tag, and the second tag for the new tenant, and
create the normal container and the quarantine container on each of the plurality of compute/storage devices.

13. The controller/orchestrator of claim 8, wherein, to classify the content, the memory storing instructions that, when executed, further cause the one or more processors to
maintain a journal for the content correlating a unique identifier, a tenant, content type, a current customer tag comprising one of the first customer tag and the second customer tag, and
update or populate the journal based on the policy attributes for the tenant.

14. The controller/orchestrator of claim 8, wherein, for suspicious content, the memory storing instructions that, when executed, further cause the one or more processors to
address the suspicious content with the second customer tag to the quarantine container on each of the plurality of compute/storage devices, and
one or more of report the suspicious content and provide a sample of the suspicious content for threat intelligence.

15. A Software Defined Quorum (SDQ) method implemented by a controller/orchestrator using Software Defined Networking (SDN), wherein the controller/orchestrator is communicatively coupled to a plurality compute/storage devices and each comprising a normal container and a quarantine container, the SDQ method comprising:
classifying content in the quorum system based on policy attributes;
addressing content to the plurality of compute/storage devices using a service tag based on networking attributes for the network; and
addressing the content to one of the normal container and the quarantine container in each of the plurality of compute/storage devices using a first customer tag for the normal container and a second customer tag for the quarantine container based on the networking attributes.

16. The SDQ method of claim 15, wherein the service tag is a Service Virtual Local Area Network Identifier (SVID), and wherein the first customer tag and the second customer tag are each a different Customer Virtual Local Area Network Identifier (CVID).

17. The SDQ method of claim 15, wherein the policy attributes are defined by a tenant and determine content type and whether modification is allowed, whether encryption is allowed, whether sampling is allowed for reporting, and associated actions.

18. The SDQ method of claim 15, wherein, to add a new tenant to the quorum system, the SDQ method further comprising:
receiving the policy attributes from the new tenant;
allocating the service tag, the first customer tag, and the second tag for the new tenant; and
creating the normal container and the quarantine container on each of the plurality of compute/storage devices.

19. The SDQ method of claim 15, wherein, to classify the content, the SDQ method further comprising:
maintaining a journal for the content correlating a unique identifier, a tenant, content type, a current customer tag comprising one of the first customer tag and the second customer tag, and
updating or populating the journal based on the policy attributes for the tenant.

20. The SDQ method of claim 15, wherein, for suspicious content, the SDQ method further comprising:
addressing the suspicious content with the second customer tag to the quarantine container on each of the plurality of compute/storage devices, and
one or more of reporting the suspicious content and providing a sample of the suspicious content for threat intelligence.
